(19) United States
(12) Patent Application Publication
(10) Pub. No.: US 2009/0121048 A1
(43) Pub. Date: May 14, 2009

(54) SPRAY GUN

(76) Inventor: Shunji Noshima, Osaka (JP)

Correspondence Address: BIRCH STEWART KOLASCH & BIRCH, PO BOX 747, FALLS CHURCH, VA, 22040-0747, US

(21) Appl. No.: 12/296,290

(22) PCT Filed: Jul. 25, 2007
(86) PCT No.: PCT/JP2007/064599

§ 371 Date: Oct. 7, 2008

(30) Foreign Application Priority Data
Jan. 30, 2007 (JP) 2007-019618

(51) Int. Cl. B05B 7/06

(52) U.S. Cl. 239/291; 239/602; 239/300

(57) ABSTRACT

The present invention has an object to provide a spray gun having a simplified nozzle shape to facilitate working the nozzle, having an improved nozzle durability, and capable of reducing a nozzle replacement frequency. The spray nozzle (3) is configured so that a coating material supply channel (12) passing a coating material from the coating material supply part (2A) of the gun main body (2) penetrates through a central portion in an axial direction, and so that a cylindrical nozzle main body having the coating material ejection hole (10) formed to be open on a tip end side of the coating material supply channel (12) and a cylindrical air guide member (6) fitted into a surrounding outside of the nozzle main body (5) are separately provided, and an annular air passage (25) supplying air from the air supply part of the gun main body toward the air ejection hole (11) is formed in the air guide member (6), the annular air passage (25) being formed by an outer circumferential surface of the nozzle main body (5) and an inner circumferential surface of the air guide member (6) along the axial direction.

### TECHNICAL FIELD

The present invention relates to a spray gun.

### BACKGROUND ART

There is well known, as a spray gun used for coating, a spray gun including a gun main body, a spray nozzle attached to this spray gun, and an air cap attached to the gun main body similarly to the spray nozzle and forming an annular air ejection hole in a state of surrounding a coating material ejection hole provided in the spray nozzle (see, for example, Patent Document 1). A conical valve seat is formed inside the coating material ejection hole. A needle valve for adjusting a coating material passing amount is provided for the valve seat in a state of being movable forward and backward so as to be able to adjust an approach/separation or an approach/separation distance of the needle valve relative to this valve seat.

A coating material is supplied to the coating material ejection hole of the spray nozzle via within the gun main body. The air is supplied to the air ejection hole of the air cap via an air supply channel formed annularly between an outer circumference of the spray nozzle and an inner circumference of the air cap from within the gun main body. The air is supplied to this air supply channel via a plurality of air communication holes formed along an axial direction of a collar on an outer circumference of the spray nozzle.

A second air ejection hole for ejecting the air toward the coating material ejected from the coating material ejection hole of the spray nozzle is formed in the air cap, and the air can be also supplied to this second air ejection hole through the gun main body.

Because of such a configuration, the coating material is blown off from the coating material ejection hole of the spray nozzle with great force to follow the force (negative pressure) of the air ejected forward from the air ejection hole of the air cap, and the air and the coating material are appropriately mixed up and diffused in the form of mist. Although this diffusion is to be transformed into a conical spread, the air ejected from the second air ejection hole acts to crush down the conical diffusion state from both sides. As a result, the coating is sprayed while being diffused in a flat conical form having an elliptical or an oval bottom.

Patent Document 1: U.S. Pat. No. 6,293,476

### DISCLOSURE OF THE INVENTION

### Problems to be Solved by the Invention

In case of a conventional spray gun, a valve seat for the needle valve provided inside the spray nozzle is gradually worn away as the needle valve moves forward or backward to adjust the passing amount of the coating material. Due to this, it is necessary to replace the spray nozzle relatively frequently.

In this case, the spray nozzle needs to include an internal structure in which the needle valve is accommodated in a freely forward and backward movable manner and in which the valve seat is formed, a collar provided on the outer circumference of the spray nozzle to be fitted concentrically with an air cap, and a plurality of air communication holes formed to penetrate through this collar along an axial direction by working the collar to form the holes.

As can be seen, the conventional spray nozzle is not easy to work because of its complicated shape. Besides, the valve seat of the conventional spray nozzle is worn badly and quickly, so that the conventional spray nozzle is low in durability.

The present invention has been made in view of the above-stated problems. It is an object of the present invention to provide a spray gun having a simplified nozzle shape to facilitate working the nozzle, having an improved nozzle durability, and capable of reducing a nozzle replacement frequency.

### Means Adapted to Solve the Problems

In the present invention, a spray gun comprises:

a gun main body including a coating material supply part and an air supply part;

a spray nozzle attached to the gun main body including a coating material ejection hole provided in a central portion and capable of adjusting a coating material passing amount using a needle valve, and an annular air ejection hole being formed around the coating material ejection hole; and

an air cap including a control air ejection hole controlling a coating spray form of the spray nozzle, and attached, together with the spray nozzle, to the gun main body, wherein

the spray nozzle is configured so that a coating material supply channel passing a coating material from the coating material supply part of the gun main body penetrates through a central portion in an axial direction, and so that a cylindrical nozzle main body having the coating material ejection hole formed to be open on a tip end side of the coating material supply channel and a cylindrical air guide member fitted into a surrounding outside of the nozzle main body are separately provided, and

an annular air passage supplying air from the air supply part of the gun main body toward the air ejection hole is formed in the air guide member, and the annular air passage is formed by an outer circumferential surface of the nozzle main body and an inner circumferential surface of the air guide member along the axial direction.

It is preferable that an annular convex portion be formed on an outer circumferential surface of a rear part of the nozzle main body, and an annular shoulder portion abutting on the annular convex portion of the nozzle main body be formed on the air guide member.

It is preferable that an abutment surface between the annular convex portion and the annular shoulder portion be a tapered surface.

It is preferable that the nozzle main body and the air guide member be assembled with the gun main body via an assembly cylindrical body threaded with the gun main body, a rear end of the nozzle main body be inserted into a tip end of the assembly cylindrical body, a rear end of the air guide member be threaded with the tip end of the assembly cylindrical body, and the coating material supply part of the gun main body and the coating material supply channel of the nozzle main body be configured to communicate with each other by the assembly cylindrical body.

It is preferable that a collar projecting outward be formed on an outer circumferential surface of the air guide member, and a conical abutment portion which concentrically positions the air cap and on which an air cap is abutted be formed on a front surface of the collar.

It is preferable that a radial hole for communicating the air supply part of the gun main body with the annular air passage be formed in the air guide member.

A tip end of the air guide member may extend up to a tip end of the nozzle main body, and the air ejection hole may be formed between an outer circumferential surface of the tip end of the nozzle main body and an inner circumferential surface of the extended end of the air guide member.

Furthermore the tip end of the air guide member may extend halfway along the axial direction of the nozzle main body, and the air ejection hole may be formed between an outer circumferential surface of the tip end of the nozzle main body and an inner circumferential surface of an annular wall formed to extend from the air cap toward the tip end of the nozzle main body.

It is preferable that the nozzle main body be made of ceramic.

Furthermore, it is preferable that a spray gun of the present invention comprise a gun main body including a coating material supply part and an air supply part;

a spray nozzle attached to the gun main body including a coating material ejection hole provided in a central portion and capable of adjusting a coating material passing amount using a needle valve, and an annular air ejection hole being formed around the coating material ejection hole; and

an air cap including a control air ejection hole controlling a coating spray form of the spray nozzle, and threadably attached, together with the spray nozzle, to the gun main body via a connection ring by a lock nut, wherein

the spray nozzle is configured so that a coating material supply channel passing a coating material from the coating material supply part of the gun main body penetrates through a central portion in an axial direction, and so that a cylindrical nozzle main body having the coating material ejection hole formed to be open on a tip end side of the coating material supply channel and a cylindrical air guide member fitted into a surrounding outside of the nozzle main body are separately provided,

the nozzle main body and the air guide member are assembled with the gun main body via an assembly cylindrical body threaded with the gun main body, and the coating material supply part of the gun main body and the coating material supply channel of the nozzle main body are configured to communicate with each other by the assembly cylindrical body, and

an annular air passage is formed in the air guide member to introduce air from the air supply part of the gun main body via a radial hole formed in the air guide member and supplies the air toward the air ejection hole, and the annular air passage is formed by an outer circumferential surface of the nozzle main body and an inner circumferential surface of the air guide member along the axial direction.

### EFFECTS OF THE INVENTION

According to the present invention, it is possible to provide a spray gun having a simplified nozzle shape to facilitate working the nozzle, having an improved nozzle durability, and capable of reducing a nozzle replacement frequency.

### BRIEF DESCRIPTION OF THE DRAWINGS

FIG. 1 is a side cross-sectional view showing a first embodiment of a spray gun according to the present invention.

FIG. 2 is a side cross-sectional view showing a spray nozzle extracted from FIG. 1.

FIG. 3 is a side cross-sectional view showing a nozzle main body extracted from FIG. 2.

FIG. 4 is a left front view of an air guide member shown to correspond to FIG. 5.

FIG. 5 is a side cross-sectional view showing the air guide member extracted from FIG. 2.

FIG. 6 is a side cross-sectional view showing an assembly cylindrical body extracted from FIG. 2.

FIG. 7 is a side cross-sectional view showing a second embodiment of a spray gun according to the present invention.

FIG. 8 is a side cross-sectional view showing a third embodiment of a spray gun according to the present invention.

FIG. 9 is a side cross-sectional view showing a fourth embodiment of a spray gun according to the present invention.

### DESCRIPTION OF REFERENCE NUMERALS

1 Spray gun
2 Gun main body
2A Coating material supply part
2B Air supply part
3 Spray nozzle
4 Air cap
5 Nozzle main body
6 Air guide member
7 Assembly cylindrical body
10 Coating material ejection hole
11 Coating-spray air ejection hole
25 Air passage
26 Radial hole
27 Second radial hole
40 Lock nut
45 Control air ejection hole
58 Auxiliary air passage
49 Auxiliary air ejection hole
52 Connection ring

### BEST MODE FOR CARRYING OUT THE INVENTION

Embodiments of the present invention will be described hereinafter based on the drawings.

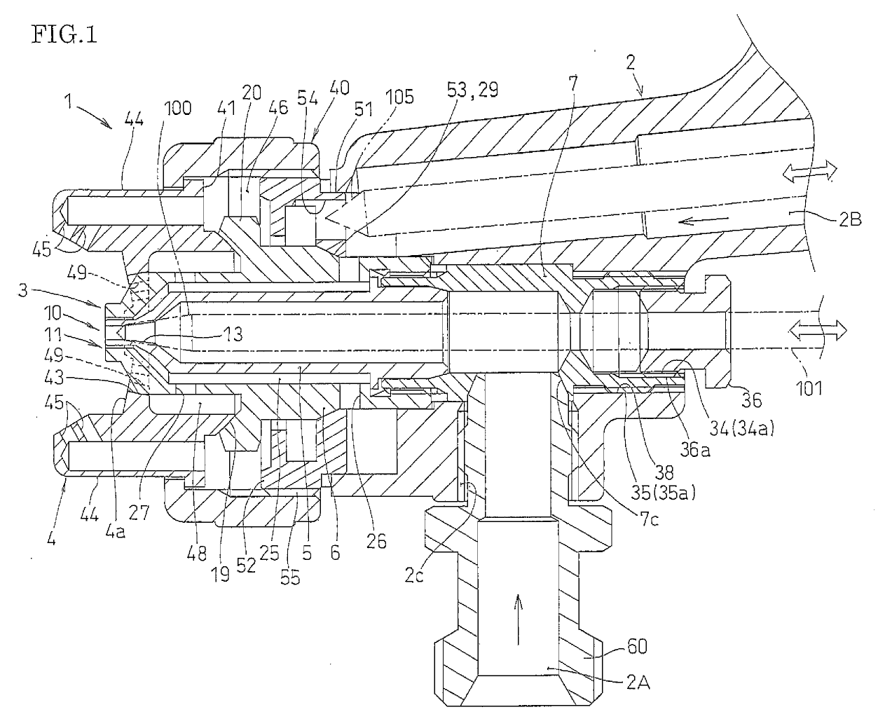

FIG. 1 is a side cross-sectional view showing a principal part (tip end portion) of a spray gun 1 according to a first embodiment of the present invention. This spray gun 1 includes a gun main body 2 and a spray nozzle 3 attached to a tip end of this gun main body 2. Further, an air cap 4 is attached to the tip end of the gun main body 2 to surround a tip end of the spray nozzle 3.

A coating material supply part 2A receiving supply of a coating material from outside and an air supply part 2B receiving supply or the air from the outside are separately provided in the gun main body 2. A needle valve 100 moved in a valve opening direction by operating a trigger lever and pressed to be urged in a valve closing direction by a spring in an ordinary state is incorporated in the coating material supply part 2A, so that a coating material passing amount can be adjusted. Furthermore, a needle valve 105 having a screwed structure is incorporated in the air supply part 2B, so that an air passing amount can be adjusted.

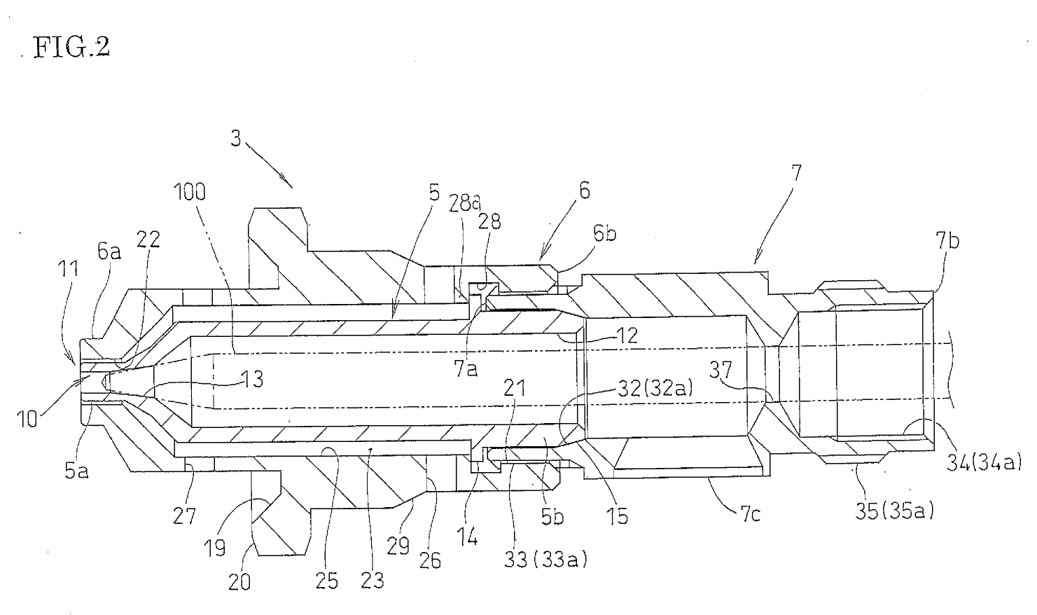

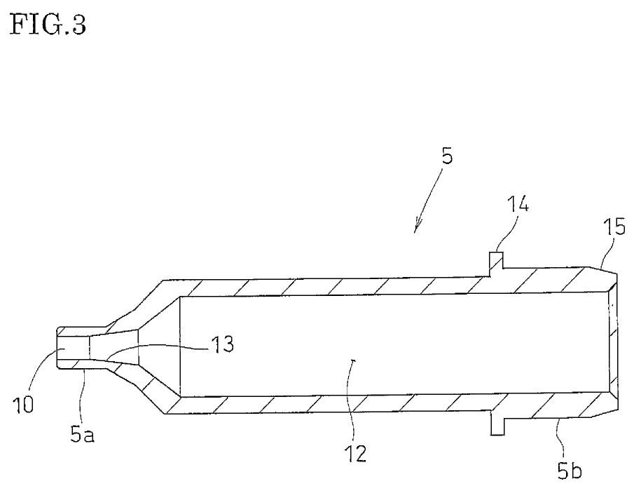

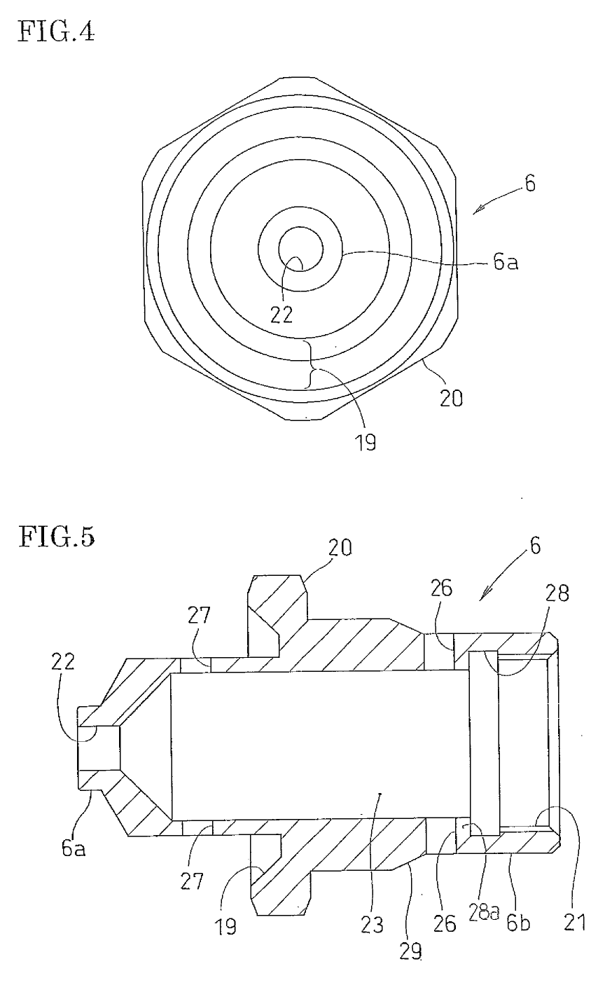

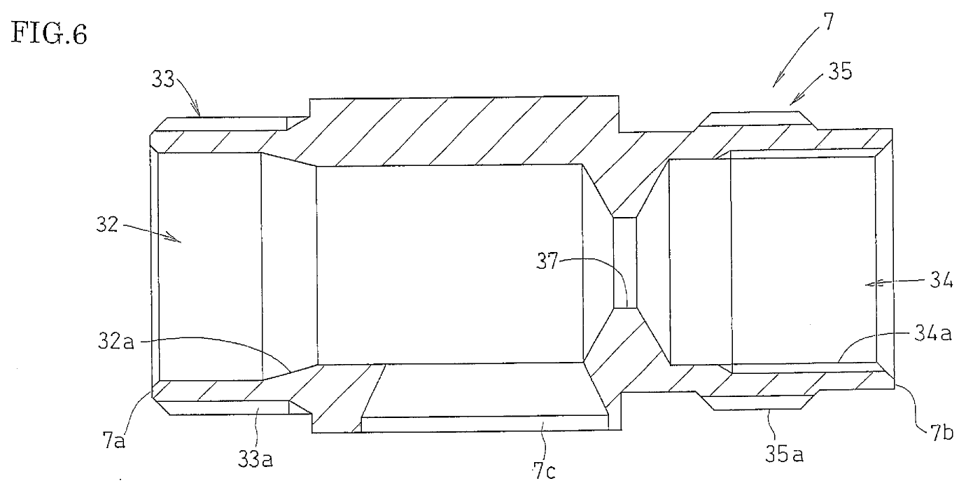

As shown in FIG. 2, the spray nozzle 3 includes a nozzle main body 5 and an air guide member 6 that can be separately decomposed (the nozzle main body 5 is shown in FIG. 3 and the air guide member 6 is shown in FIGS. 4 and 5). This spray nozzle 3 also includes an assembly cylindrical body 7 (shown in FIG. 6) for concentrically assembling the nozzle main body 5 and the air guide member 6 into the gun main body 2, and the spray nozzle 3 can be attached to the gun main body 2 via this assembly cylindrical body 7. An outer circumferential surface of a rear end 5b of the nozzle main body 5 is taper-fitted (inserted) into an inner circumferential surface of a tip end 7a of the assembly cylindrical body 7. An inner circumferential surface of a rear end 6b of the air guide member 6 is threaded with an outer circumferential surface of the tip end 7a of the assembly cylindrical body 7. A lateral hole 7c communicating with the coating material supply part 2a of the gun main body 2 is formed halfway along an axial direction of the assembly cylindrical body 7. A coating material connection pipe 60 is attached to the coating material supply part 2A. The coating material connection pipe 60 is threadably connected to a connection port 2C formed on a lower surface slightly in rear of a tip end of the gun main body 2, and a tip end of the coating material connection pipe 60 is fitted into the lateral hole 7c of the assembly cylindrical body 7, thereby preventing the assembly cylindrical body 7 from rotating.

The nozzle main body 5 and the air guide member 6 are assembled to be concentric with each other. A coating material ejection hole 10 is provided on a tip end 5a of the nozzle main body 5, and an annular coating-spray air ejection hole 11 is formed between tip ends of the nozzle main body 5 and the air guide member 6 (in an annular gap between an outer circumferential surface of the tip end 5a of the nozzle main body 5 and an inner circumferential surface of a tip end 6a of the air guide member 6). Naturally, therefore, the coating material ejection hole 10 and the coating-spray air ejection hole 11 are concentric with each other.

As shown in FIG. 3, the nozzle main body 5 is formed into a straight cylindrical shape having the tip end 5a closed tight. The coating material ejection hole 10 is formed while penetrating through a tight closed portion of the tip end 5a in an axial direction. A cylindrical hole formed in the nozzle main body 5 serves as a coating material supply channel 12. On this coating material supply channel 12, a tapered surface a diameter of which is smaller in a forward direction is formed inside the coating material ejection hole 10. This tapered surface forms a valve seat 13 for the needle valve 100 for adjusting the coating material passing amount.

In the first embodiment, a tight closed portion of the tip end 5a of the nozzle main body 5 is formed into a cylindrically protruding shape, so that the coating material ejection hole 10 formed inside the nozzle main body 5 is a straight hole having a predetermined length. Due to this, a straight advance directivity is given to the coating material sprayed via this coating material ejection hole 10 and a spray distance of the coating material can be made as large as possible.

An annular convex portion 14 projecting circumferentially is provided on a rear end 5b side outer circumferential surface of the nozzle main body 5. A rear part of the nozzle main body 5 on this annular convex portion 14 that is a border between the rear part and a front part of the nozzle main body 5 is formed to be slightly thicker than the front part of the nozzle main body 5. Furthermore, the outer circumferential surface of the rear end 5b of the nozzle main body 5 is formed as the tapered surface 15 the diameter of which is smaller in a rearward direction.

As stated, the nozzle main body 5 is generally straight cylindrical body except for formation of the Light closed portion of the tip end 5a, the tapered surface 15 of the rear end 5b, and the annular convex portion 14. The nozzle main body 5 has a simple structure without a complicated structure such as a screw and is a thin cylindrical component except for a slightly thicker portion near the rear end 5b. Therefore, the nozzle main body 5 can be formed out of a formation material such as ceramic. Due to this, the nozzle main body 5 can be provided as a component excellent in wear resistance.

As shown in FIGS. 4 and 5, the air guide member 6 is formed using, as a basic shape, a cylindrical shape one size larger in diameter than the nozzle main body 5. The tip end 6a of the air guide member 6 is closed tight, a collar 20 projecting circumferentially is provided on an outer circumferential surface of an axially central portion of the air guide member 6, and a female screw 21 is formed on the inner circumferential surface of the rear end 6b.

An outer circumferential surface of the collar 20 is formed into a regular polygon such as a regular hexagon in a front view so as to be engaged with such a tool as a spanner, and used to connect or separate the air guide member 6 to or from the assembly cylindrical body 7 or to attach or detach the spray nozzle 3 to or from the gun main body 2. Moreover, a tapered outside surface 29 is formed on the outer circumferential surface of the air guide member 6 in rear of the collar 20 to abut on a tapered inside surface 53 of a connection ring 52 closing a tip end opening 51 of the gun main body 2 during attachment of the air guide member 6 to the gun main body 2, to press the connection ring 52 axially, and to close the opening 51. The connection ring 52 includes one valve hole 54 adjusting an air passing amount supplied from the air supply part 2B of the gun main body 2 to the air cap 4. The connection ring 52 is configured to be able to be attached to the gun main body 2 to position this valve hole 54 relative to the needle valve 105.

In the first embodiment, a tapered concave portion 19 is formed in a front surface of the collar 20 for concentrically positioning and abutting the air cap 4 relative to and on the tapered concave portion 19. A conical tapered convex portion of the rear end of the air cap 4 is rotatably fitted into and abutted on this tapered concave portion 19 (see FIG. 1). The tapered concave portion 19 may be a conical abutment portion.

In the air guide member 6, a tip end hole 22 penetrating axially is formed in a tight closed portion of the tip end portion 6a. The tip end 5a of the nozzle main body 5 can be fitted into this tip end hole 22. Further, the tip end hole 22 is formed to have an inner diameter so as to be able to circumferentially form a constant annular gap (corresponding to the coating-spray air ejection hole 11 stated above) around the tip end 5a of the nozzle main body 5.

In the first embodiment, the tight closed portion of the tip end 6a of the air guide member 6 is formed into a cylindrically protruding shape, so that the tip end hole 22 formed inside the air guide member 6 is a straight hole having a predetermined length. Accordingly, the coating-spray air ejection hole 11 formed by fitting the tip end 5a of the nozzle main body 5 (the tight closed portion of the cylindrically protruding shape) into the tip end hole 22 is also a straight cylindrical hole having a predetermined length. Due to this, a straight advance directivity is given to the air sprayed via this coating-spray air ejection hole 11 (unnecessary diffusivity of the air is suppressed), and a spray distance of the air can be made as large as possible.

A front part of a cylindrical hole 23 formed inside the air guide member 6 communicates with the tip end hole 22, and a rear part thereof is through the female screw part 21 and open. The front part of the nozzle main body 5 relative to the annular convex portion 14 can be inserted into the cylindrical hole 23. Further, the cylindrical hole 23 is formed to have an inner diameter so as to be able to circumferentially form a constant annular gap around the nozzle main body 5. Needless to say, the annular gap formed therein communicates with the coating-spray air ejection hole 11 formed by the tip end hole 22 and the surrounding of the tip end 5a of the nozzle main body 5, thereby forming an air passage 25 (see FIG. 2).

A radial hole 26 penetrating through a cylindrical wall is formed at a position in rear of the collar 20 and in front of the female screw 21. This radial hole 26 keeps the air passage 25 communicating an interior and an exterior of the air guide member 6 with each other. While the number of the radial hole 26 may be at least one, a plurality of radial holes 26 is preferably formed along a circumferential direction of the cylindrical wall. By providing the radial hole 26, the air passage 25 is turned into a state of communicating with the air supply part 2B of the gun main body 2 when the spray nozzle 3 is incorporated in the gun main body 2.

A second radial hole 27 penetrating through the cylindrical wall is formed at a position in front of the collar 20 and in rear of the tip end hole 22. Similarly to the radial hole 26, this second radial hole 27 keeps the air passage 25 communicating the interior and the exterior of the air guide member 6 with each other. The situation in which the number of the radial hole 26 may be one or two or more is the same as that for the radial hole 26. An air passage formed by providing the second radial hole 27 will be described later.

The female screw 21 is formed to have an inner diameter (an inner diameter at a screw thread) larger than an inner diameter of the cylindrical hole 23, and an annular concave portion 28 enlarged radially is formed at a position that is a deepest portion of the female screw 21 and that serves as a boundary with the cylindrical hole 23. The annular concave portion 28 acts to facilitate working the female screw 21 and to abut the annular convex portion 14 of the nozzle main body 14 on an annular shoulder portion 28a formed at a position facing the cylindrical hole 23 from the annular concave portion 28 to position the annular convex portion 14 (see FIG. 2).

The air guide member 6 may be produced by being cut out from a pure material or a casting material using an appropriate metal such as brass, aluminum, copper, iron or stainless steel as a formation material. A resin may be used as the formation material depending on situations.

As shown in FIG. 6, the assembly cylindrical body 7 is formed using a cylindrical shape generally similar to the air guide member 6 as a basic shape. A connection part 32 for the nozzle main body 5 is provided on the inner circumferential surface of the tip end 7a, and a connection part 33 for the air guide member 6 is provided on the outer circumferential surface of the tip end 7a.

A conical tapered surface 32a is formed on the connection part 32 for the nozzle main body 5 so as to be able to be taper-fitted into the tapered surface 15 formed on the rear end 5b of the nozzle main body 5. A male screw 33a is provided on the connection part 33 for the air guide member 6 so as to be able to be threaded with the female screw 21 provided on the rear end 6b of the air guide member 6.

A tail cap connection part 34 and a connection part 35 are provided on the rear end 7b of the assembly cylindrical body 7. The tail cap connection part 34 is used to attach a tail cap 36 (see FIG. 1) slidably holding a valve shaft 101 of the needle valve 100 and preventing leakage of the coating material to the tail cap connection part 34. In the first embodiment, the tail cap 36 includes a male screw 36a, and a female screw 34a that can be threaded with the male screw 36a is formed on the tail cap connection part 34.

In the first embodiment, a valve bearing 37 formed to have a reduced inner diameter is provided halfway along the axial direction of the assembly cylindrical body 7 so as to be able to support the valve shaft 101 of the needle valve 100 at two points. The valve shaft 101 can thereby smoothly and stably slider thereby ensuring that the needle valve 100 abuts on and separate from the valve seat 13 of the nozzle main body 5 in a coaxial relation and preventing irregular wearing.

Moreover, the connection part 35 is used to attach the entire spray nozzle 3 to the gun main body 2. In the first embodiment, a female screw 38 is provided on the gun main body 2 side (see FIG. 1), and a male screw 35a that can be threaded with the female screw 38 is formed on the connection part 35.

As obvious from FIG. 2, in a state of forming the spray nozzle 3 by connecting the nozzle main body 5, the air guide member 6, and the assembly cylindrical body 7 to one another, the tapered surface 15 on an outer circumference of the rear end 5b of the nozzle main body 5 is taper-fitted into the tapered surface 32a on an inner circumference of the connection part 32 for the nozzle main body 5 of the assembly cylindrical body 7. The annular shoulder portion 28a formed at a position facing the cylindrical hole 23 from the annular concave portion 28 of the air guide member 6 presses the annular convex portion 14 of the nozzle main body 5 backward, thereby intensifying the tapered fitting of the tapered surface 15 into the tapered surface 32a and threading the female screw 21 on an inner circumference of the rear end 6b of the air guide member 6 with the male screw 33a on an outer circumference of the connection part 33 for the air guide member 6 of the assembly cylindrical body 7.

As shown in FIG. 1, the air cap 4 is attached to the tip end of the gun main body 2 by threading a short cylindrical lock nut 40 with a male screw 55 on an outer circumferential surface of the connection ring 52. Due to this, an annular rib 41 is formed on an outer circumference of the air cap 4 for engaging the lock nut 40 with the male screw 55 in the axial direction but for holding the air cap 4 in a rotatable state in a circumferential direction.

This air cap 4 includes a central opening 43 formed in a front wall 4a and having a large opening diameter so as to penetrate through the tip end of the spray nozzle 3 and to protrude forward, and a pair of upper and lower protrusions (angular portions=horns) 44 protruding forward in angular manners at both radial positions across the central opening 43, respectively. Control air ejection holes 45 are formed in the protrusions 44 on the both sides.

The air is supplied from the air supply part 2B within the gun main body 2 via the valve hole 54 of the connection ring 52 and via an air passage 46 formed annularly between an outer circumference of the air guide member 6 and an inner circumference of the lock nut 40 in the spray nozzle 3. Therefore, the air fed from this air passage 46 into the respective protrusions 44 is ejected from the control air ejection holes 45. The ejected air cover up outside of the spray nozzle 3 and controls the spray form of the coating material sprayed from the tip end of the spray nozzle 3 in a conical fashion to be transformed into a flat conical form having an elliptical or an oval bottom. Due to this, by causing the needle valve 105 to control the air passing amount of the air from the valve hole 54 of the connection ring 52, it is possible to control the spray form of the coating material and to apply coating according to usage, purpose or the like.

As stated above, the air cap 4 is held by the tip end of the gun main body 2 in the rotatable state. Therefore, by adjusting a rotational angle of the air cap 4, a spray position of the air ejected from the control air ejection holes 45 of the protrusions 44 can be changed relatively to the spray form of the coating material sprayed from the tip end of the spray nozzle 3 in the conical fashion.

Namely, in a case where the spray form of the coating material sprayed from the tip end of the spray nozzle 3 is transformed to the flat conical form having the elliptical or oval bottom, it is possible to arbitrarily select a position at which the elliptical or oval form is transformed to an elongated form, to an oblong form or to an inclined form.

In a portion of the air cap 4 which portion surrounds a front part relative to the collar 20 provided on the spray nozzle 3 (air guide member 6), an annular auxiliary air passage 48 is formed between the outer circumference of the spray nozzle 3 and an inner circumference of the air cap 4. This auxiliary air passage 48 is partitioned by the contact between an inner circumferential surface of the central opening 43 of the air cap 4 and an outer circumferential surface of the spray nozzle 3 protruding from the central opening 43.

On the other hand, a plurality of auxiliary air ejection holes 49 is formed in the front wall 4a of the air cap 4 (that is, an opening circumference of the central opening 43) at predetermined intervals to correspond to the auxiliary air passage 48. Accordingly, the air is supplied to these auxiliary air ejection holes 49 via the auxiliary air passage 48 and sprayed forward.

As stated, the auxiliary air passage 48 communicates with the air passage 25 formed between the cylindrical hole 23 of the air guide member 6 and an outer circumference of the nozzle main body 5 via the second radial hole 27 of the spray nozzle 3. Since this air passage 25 communicates with the air supply part 2B of the gun main body 2 via the radial hole 26 on the rear part of the spray nozzle 3, the air supplied from the gun main body 2 side to the air passage 25 is subsequently branched off to the auxiliary air ejection holes 49 halfway.

In this way, the air ejected forward from the auxiliary air passage 48 via the auxiliary air ejection holes 49 turns into a state of forming a curtain preventing the coating material sprayed from the tip end of the spray nozzle 3 from diffusing, thereby making it advantageously possible to blow off the coating material farther.

In the first embodiment, each of the auxiliary air ejection holes 49 is formed in a state of being inclined inwardly with respect to the axial direction. Alternatively, the auxiliary air ejection holes 49 may be formed in parallel to the axial direction.

As obvious from the detailed description given so far, in the spray gun 1 according to the present invention, the spray nozzle 3 is formed to include the nozzle main body 5 and the air guide member 6. Therefore, only the nozzle main body 5 can be set as a replaceable component. In this case, the air passage 25 is formed between the inner and outer circumferential surfaces of the nozzle main body 5 and the air guide member 6, whereby there is no need to work the spray nozzle 3 to form axial holes.

Due to this, the nozzle main body 5 can be formed out of a thin cylindrical component at low cost and does not need to be subjected to complicate working such as formation of axial holes or the like. Because of no need of the complicated working, the nozzle main body 5 can be formed using ceramic excellent in wearing resistance as a formation material. It is thereby possible to suppress the replacement frequency to be low and eventually produce an advantage of removing user's burden of a replacement operation.

Since the radial hole 26 is formed in the air guide member 6, there is no need to bother to form axial holes. Due to this, the air guide member 6 (a component that is not planned to be frequently replaced) can be formed out of a thin cylindrical component at low cost and does not need to be subjected to complicated working. Hence, the spray gun 1 can be manufactured at low cost as a whole.

Since the spray nozzle 3 is attached to the gun main body 2 via the assembly cylindrical body 7, the attachment of the spray nozzle 3 to the gun main body 2 is simple and assured. Besides, to make a distances between inner and outer circumferences of the nozzle main body 5 and the air guide member 6 constant (to improve concentric accuracy) is simple and assured. This can eventually improve performance of the spray gun 1 as a coating device.

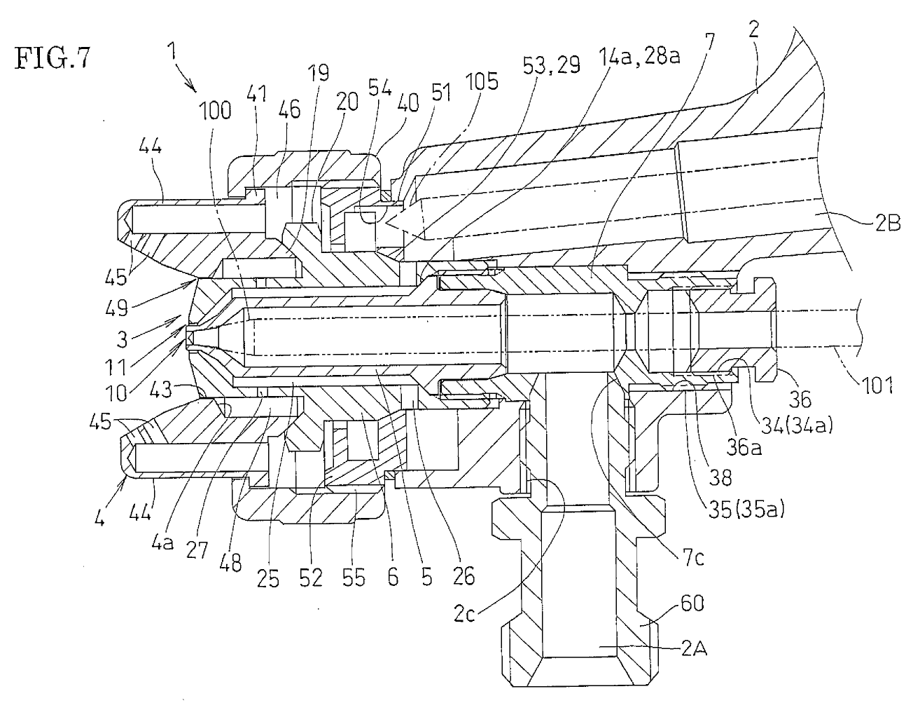

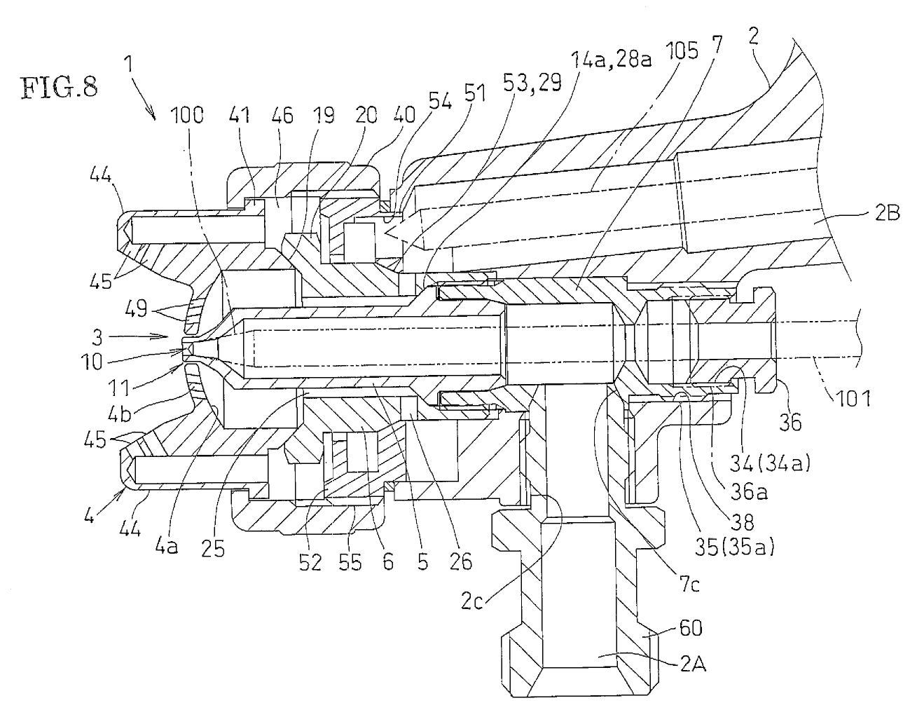

FIG. 7 is a side cross-sectional view showing a spray gun according to a second embodiment of the present invention. An abutment surface of the annular convex portion 14 on the outer circumferential surface of the nozzle main body 5 against the annular shoulder portion 28a on the inner circumferential surface of the air guide member 6 is formed as a tapered abutment surface 14a. The tapered abutment surface 14a is taper-fitted into the annular shoulder portion 28a. In the second embodiment, the concentricity between the nozzle main body 5 and the air guide member 6 is improved as compared with the first embodiment. The other constituent elements according to the second embodiment are almost similar to those according to the first embodiment stated above. In the second embodiment, same constituent elements are denoted by same reference symbols as those according to the first embodiment and not described herein.

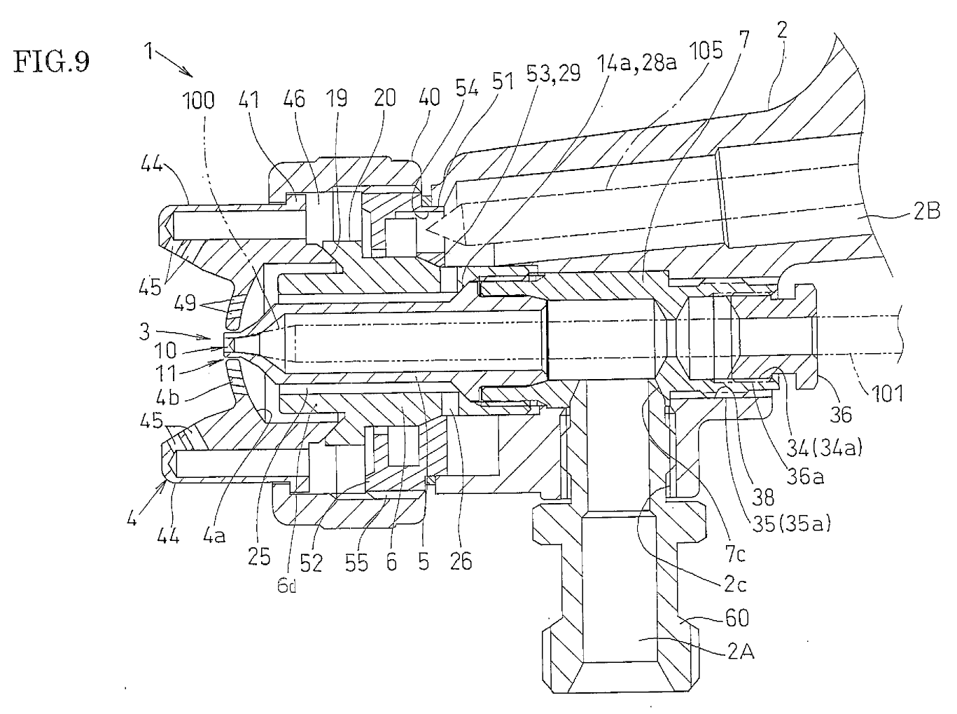

FIGS. 8 and 9 are side cross-sectional views showing spray guns according to third and fourth embodiments of the present invention, respectively. In each of the third and fourth embodiments, a tip end of the air guide member 6 extends not to the tip end of the nozzle main body 5 but halfway of the tip end of the nozzle main body 5, the front wall 4a of the air cap 4 extends in a central direction, and an annular wall 4b for forming the air ejection hole 11 communicating with the air passage 25 and ejecting the coating-spray air is formed integrally with the air cap 4 around the tip end of the nozzle main body 5. The auxiliary air ejection holes 49 are appropriately formed in the annular wall 4b and the air is directly supplied from the air passage 25 to the auxiliary air ejection holes 49. By ejecting the air from the auxiliary air ejection holes 49, the ejected air acts as an air curtain preventing diffusion of the sprayed coating material ejected forward from the air ejection hole 11 and the coating material ejection hole 10 in the central portion and the straight advance directivity can be improved. Nevertheless, the auxiliary air ejection hole 49 may be omitted depending on usage or purpose. The other constituent elements according to the third and fourth embodiments are almost similar to those according to the first and second embodiments. In the third and fourth embodiments, same constituent elements are denoted by same reference symbols as those according to the first and second embodiments and are not described herein.

The third embodiment and the fourth embodiment differ in following respects. Namely, in the third embodiment, the air guide member 6 has a simplified tip end shape by forming the tip end up to a position of the collar 20 to thereby reduce the length of the tip end and by not forming the air ejection hole 11. On the other hand, in the fourth embodiment, the air guide member 6 has the tip end slightly extending forward of the collar 20 but the length of the tip end is smaller than those of the first and second embodiments, and the air guide member 6 has a simplified tip end shape by not forming the air ejection hole 11. Furthermore, an outer circumferential surface of a portion 6d extending forward of the collar 20 is formed into a regular polygon such as a hexagon with which such a tool as a spanner is engaged. The outer circumferential surface of the collar 20 is formed into not a regular polygon but a circle smaller in diameter than the regular polygon instead, thereby reducing the resistance of the air communicating toward the air cap 4.

The embodiments of the present invention have been described so far. However, the present invention is not limited to the above-stated embodiments but appropriate changes can be made of the present invention.

### INDUSTRIAL APPLICABILITY

While the spray gun according to the present invention is suitably used for a coating operation, the spray gun according to the present invention is also applicable to spraying of medical solutions or spraying of liquid manure in fruit growing, gardening and the like and further applicable to the other usages.

1-10. (canceled)

11. A spray gun comprising:
a gun main body including a coating material supply part and an air supply part;
a spray nozzle attached to the gun main body including a coating material ejection hole provided in a central portion and capable of adjusting a coating material passing amount using a needle valve, an annular air ejection hole being formed around the coating material ejection hole; and
an air cap including a control air ejection hole controlling a coating spray form of the spray nozzle, and attached, together with said spray nozzle, to said gun main body, wherein
said spray nozzle is configured so that a coating material supply channel passing a coating material from the coating material supply part of said gun main body penetrates through a central portion in an axial direction, and so that a cylindrical nozzle main body having the coating material ejection hole formed to be open on a tip end side of the coating material supply channel and a cylindrical air guide member fitted into a surrounding outside of said nozzle main body and communicated an inner circumferential surface with the air supply part of said gun main body are separately provided, and
an annular air passage supplying air from the air supply part of said gun main body toward said air ejection hole is formed in said air guide member, the annular air passage being formed by an outer circumferential surface of said nozzle main body and an inner circumferential surface of the air guide member along the axial direction.

12. The spray gun according to claim 11, wherein
an annular convex portion is formed on an outer circumferential surface of a rear part of said nozzle main body, and an annular shoulder portion abutting on the annular convex portion of said nozzle main body is formed on the air guide member.

13. The spray gun according to claim 12, wherein
an abutment surface between said annular convex portion and said annular shoulder portion is a tapered surface.

14. The spray gun according to claim 11, wherein
said nozzle main body and said air guide member are assembled with said gun main body via an assembly cylindrical body threaded with the gun main body, a rear end of said nozzle main body is inserted into a tip end of the assembly cylindrical body, a rear end of said air guide member is threaded with the tip end of the assembly cylindrical body, and the coating material supply part of said gun main body and the coating material supply channel of said nozzle main body are configured to communicate with each other by said assembly cylindrical body.

15. The spray gun according to claim 11, wherein
a collar projecting outward is formed on an outer circumferential surface of said air guide member, and a conical abutment portion which concentrically positions the air cap and on which an air cap is abutted is formed on a front surface of the collar.

16. The spray gun according to claim 11, wherein
a radial hole for communicating the air supply part of the gun main body with said annular air passage is formed in said air guide member.

17. The spray gun according to claim 11, wherein
a tip end of said air guide member extends tip to a tip end of said nozzle main body, and said air ejection hole is formed between an outer circumferential surface of the tip end of said nozzle main body and an inner circumferential surface of said extended end of said air guide member.

18. The spray gun according to claim 11, wherein
a tip end of said air guide member extends halfway along the axial direction of said nozzle main body, and said air ejection hole is formed between an outer circumferential surface of the tip end of said nozzle main body and an inner circumferential surface of an annular wall formed to extend from said air cap toward the tip end of said nozzle main body.

19. The spray gun according to claim 11, wherein
said nozzle main body is made of ceramic.

20. A spray gun comprising:
a gun main body including a coating material supply part and an air supply part;
a spray nozzle attached to the gun main body including a coating material ejection hole provided in a central portion and capable of adjusting a coating material passing amount using a needle valve, an annular air ejection hole being formed around the coating material ejection hole; and
an air cap including a control air ejection hole controlling a coating spray form of the spray nozzle, and threadably attached, together with said spray nozzle, to said gun main body via a connection ring by a lock nut, wherein
said spray nozzle is configured so that a coating material supply channel passing a coating material from the coating material supply part of said gun main body penetrates through a central portion in an axial direction, and so that a cylindrical nozzle main body having the coating material ejection hole formed to be open on a tip end side of the coating material supply channel and a cylindrical air guide member fitted into a surrounding outside of said nozzle main body and communicated an inner circumferential surface with the air supply part of said gun main body are separately provided,
said nozzle main body and said air guide member are assembled with said gun main body via an assembly cylindrical body threaded with the gun main body, and the coating material supply part of said gun main body and the coating material supply channel of said nozzle main body are configured to communicate with each other by said assembly cylindrical body, and
an annular air passage is formed in said air guide member to introduce air from the air supply part of said gun main body via a radial hole formed in said air guide member and supplying the air toward said air ejection hole, the annular air passage being formed by an outer circumferential surface of said nozzle main body and an inner circumferential surface of the air guide member along the axial direction.
